(19) United States
(12) Patent Application Publication
(10) Pub. No.: US 2025/0223437 A1
(43) Pub. Date: Jul. 10, 2025

(54) COMPOSITIONS COMPRISING BIODEGRADABLE THERMOPLASTIC BLENDS WITH PLASTICIZERS AND THE METHOD OF PRODUCTION

(71) Applicant: Erthos Inc., Mississauga (CA)

(72) Inventors: Hossein ABDOLI, Mississauga (CA); Nima ZARRINBAKHSH, Mississauga (CA); Emmanuel OGUNSONA, Mississauga (CA)

(21) Appl. No.: 18/404,507

(22) Filed: Jan. 4, 2024

(51) Int. Cl. C08L 67/04; B29B 7/00; B29C 48/00; B29C 48/08; B29K 67/00; C08K 5/11; C08L 67/02

(52) U.S. Cl. CPC C08L 67/04; B29B 7/005; B29C 48/022; B29C 48/08; C08K 5/11; C08L 67/02; B29C 2948/92704; B29K 2067/006; B29K 2067/046; C08L 2201/06; C08L 2203/16; C08L 2203/30

(57) ABSTRACT

The invention encompasses biodegradable thermoplastic compositions that exhibit force and form recovery. In various embodiments, the invention encompasses thermoplastic polymer compositions comprising at least one biodegradable thermoplastic polymer and at least one plasticizer, and optionally other additives including but not limited to compatibilizers, fillers, coupling agents, and initiators. In various embodiments, different levels of recovery can be achieved through resin preparation from different ingredient combinations and concentrations. The compositions comprise physical and mechanical properties for use in film and injection molding applications.

### FIELD OF INVENTION

The invention encompasses biodegradable thermoplastic polymer compositions for applications, such as extruded films, sheets, and profiles as well as injection molded rigid parts, comprising “force recovery” properties as a targeted main advantage of the mechanical properties of the inventive compositions. Moreover, the invention encompasses the use of a specified weight percentage ranges of additives and biodegradable thermoplastic polymers combinations, and protocols for the production of biodegradable resins and evaluation of their force recovery.

### BACKGROUND OF THE INVENTION

In the realm of conventional and petroleum-based polymeric materials, the force recovery behavior is present in elastomeric materials as observed from their strain recovery property. Such elastomeric materials include styrene block copolymers, thermoplastic polyolefin elastomers, thermoplastic copolyesters and thermoplastic polyurethanes, natural rubber and butadiene rubber just to mention a few. The strain recovery of these elastomers can accommodate high strains at high strain rates and return to their original shape and form with little to no loss in strength. The elasticity of polymeric materials is of great relevance in real-life applications. Some examples of functional applications of polymers with great elasticity include:
1. Seals and gaskets: Polymers with good elasticity are often used to make seals and gaskets, as deformation can occur to fit around other components while also creating a resistance to the deformation as the material tends to return to its original shape and form, thereby creating a tight seal.
2. Sporting goods: The elasticity of a polymer can affect the performance of sporting goods, such as balls and gloves. For example, a golf ball with a high elasticity coefficient will compress upon impact and disperse that energy relatively quickly by returning to its original shape and form, resulting in higher launch momentum and therefore, longer distance traveled.
3. Packaging: Elastic polymers are often used in packaging to create stretch wraps or films, which can be stretched around a stack of items or containers; a resistance to stretching by the film creates a tight and secure seal and hold.
4. Medical devices: Medical devices and consumables such as gloves, catheters and stents are made from these types of polymers as they can conform to the shape of the body to provide support.

Overall, the elasticity of a polymer is an important factor to consider in a variety of applications, as it not only affects the performance and durability but also the functionality of the final product. However, most thermoplastic polymers or thermoplastic polymer blends with excellent elasticity do not typically exhibit rubber-like “recovery” or force recovery properties; they are significantly limited in recovering the original shape and property when strained and released. Likewise, the majority are synthesized from petroleum sources with few produced from bio-based and biodegradable materials.

Biodegradable polymers typically do not exhibit this rubber-like property, which restricts utilization in many applications that require some amount of elasticity. Hence, research into modifying biopolymers has garnered a lot of interest in improving ductility. However, no investigation has been reported on the recovery property. The blending of two or more biopolymers has become a popular and effective method to improve mechanical performance. This provides an opportunity to harness the desired properties of the individual polymers. Most biopolymers have very poor ductility, which limits the application scopes. Hence, researchers all over the world have focused on ways to impart ductility, elasticity and flexibility to those biopolymers while maintaining biodegradability.

Blending biodegradable thermoplastic polymers with other petroleum-based polymers can achieve these properties but are detrimental to biodegradation in most scenarios. Hence, these blends with petroleum-based polymers are not viable or an option for achieving a biodegradable composition with recovery. Therefore, biodegradable additives blended with biodegradable/compostable polymers provide a pathway to achieving biodegradable composition with recovery. To the best of our knowledge, no literature describes the ability of bio-based and/or biodegradable polymers to achieve “recovery” after being stretched to a significant percentage of its original length. Furthermore, there is no literature or patent on the development of resins for the production of films with this property.

### SUMMARY OF THE INVENTION

The invention encompasses biodegradable thermoplastic resin compositions which exhibit a range of force recovery properties with good mechanical properties required for various plastic applications.

In accordance with this invention, a combination of biopolymers and plasticizers, and optionally other additives including, but not limited to, fillers, coupling agents, compatibilizers and initiators are disclosed to be used in melt blending processes in specific weight ratios to make compositions with force recovery properties. The resin composition development can either be performed in one or multiple-stage processes, which encompasses different ingredient compositions and concentrations.

The resin development process extends the range of molecular weights of the different polymers that can be used and melt-blended at various weight ratios.

Generally, the invention encompasses a composition comprising a biodegradable resin comprising in parts by mass (w/w) of about 10 to about 99.99 of at least one biodegradable polymer such as polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs), and combinations thereof. In various embodiments, the amount of the biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%.

In one embodiment, the biodegradable resin further includes in parts by mass (w/w) of about 0.01 to about 40 of at least one plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In various embodiments, the plasticizers include, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In another embodiment, the biodegradable resin further include in parts by mass (w/w) of about 0 to about 10 of at least one bio-based organic acid compatibilizer including, but not limited to lactic acid, formic acid, stearic acid, tannic acid, malic acid, citric acid, aspartic acid, ascorbic acid, acetic acid, tartaric acid. In various embodiments, the amount of the organic acid compatibilizer is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable resin further include, in parts by mass (w/w) of about 0 to about 10 of one or more coupling agents which encompasses both short and long-chain hydrocarbons with functional groups such as but not limited to epoxides, hydroxyls, anhydrides and citrates. In various embodiments, the amount of the coupling agent is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable resin further include, in parts by mass (w/w) of about 0 to about 20 of one or more fillers which encompasses both inorganic and biomass fillers and a combination thereof. In various embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, or about 20%.

In certain embodiments, the inorganic fillers are, but not limited to, wollastonite, mica, clay, calcium carbonate, glass fiber, talc, aluminum silicate, silicon dioxide, zirconium oxide, sepiolite, gypsum, and other minerals and a combination thereof.

In certain embodiments, the biomass includes, but not limited to, distillers' grains vinasse, vinegar residues, wood fiber, virgin starch, modified starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the composition could further include compatibilizers, chain extenders, peroxides, initiators, pigments, cross-linkers, or a combination thereof in a weight ratio ranging from about 0 to about 10 wt. %. In various embodiments, the amount of the one or more compatibilizers, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In certain embodiments, the composition exhibits a bio-based carbon content of up to 100%.

In certain embodiments, the composition exhibits an MFI or MFR (melt flow index or melt flow rate) of as low as 9 and as high as 44 g/10 min at 190° C.

In certain embodiments, the resin composition includes a combination of any of the following polymers: polylactic acid, polycaprolactone, polybutylene succinate, polybutylene succinate adipate, polybutylene succinate terephthalate, polybutylene adipate-co-terephthalate, polyhydroxyalkanoates.

In one embodiment, the polymer is a mixture of polylactic acid and polybutylene adipate terephthalate.

In one embodiment, the polymer is a mixture of polylactic acid and polycaprolactone.

In one embodiment, the polymer is a mixture of polylactic acid and polybutylene succinate.

In one embodiment, the polymer is a mixture of polylactic acid and polycaprolactone.

In one embodiment, the polymer is a mixture of polylactic acid and polybutylene succinate adipate.

In one embodiment, the polymer is a mixture of polylactic acid, polybutylene adipate terephthalate and polybutylene succinate adipate.

The embodiments are not limited only to the abovementioned combinations of biodegradable thermoplastic polyesters and could encompass any other combinations of two or more of the thermoplastic polyesters.

In certain embodiments, the composition exhibits a force recovery of more than 10%, in machine direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 8% in transverse direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 6%, in machine direction, after an initial strain of 20% was applied at a rate of 500 mm/min and then reduced to a holding strain of 6% at a rate of 500 mm/min and held constant for 12 seconds.

In certain embodiments, the composition exhibits a force recovery of more than 7% in transverse direction, after an initial strain of 20% was applied at a rate of 500 mm/min and then reduced to a holding strain of 6% at a rate of 500 mm/min and held constant for 12 seconds.

In other embodiments, the invention encompasses a method for preparing the biodegradable composition comprising the following steps:
a. mixing of all the polymers by means of a batch mixer or an extruder for a prescribed time period at temperatures higher than ambient temperatures to prepare a polymer melt,
b. mixing of additives such as plasticizers, compatibilizers, fillers, etc. to the polymer melt for another prescribed period of time to make the final resin.

In other embodiments, the invention encompasses a method for preparing the biodegradable composition comprising the following steps:
a. mixing of all the polymers and additives such as plasticizers, compatibilizers, fillers, together by means of a batch mixer or an extruder for a prescribed time period at temperatures higher than ambient temperatures to make the final resin.

The order of adding ingredients is not limited to the aforementioned methods and could include any other orders and combinations.

In certain embodiments, the method further comprises forming any articles in any shape and rigidity using conventional polymer processing techniques such as thermoforming, hot press, vacuum forming, cast extrusion, film blowing, injection molding or compression molding.

In one embodiment, the process of producing the resin formulation includes extrusion, where the extrudate is formed at a temperature above ambient temperature, preferably in a range of about 50 to about 250° C.

In certain embodiments, the invention encompasses a disposable product, comprising the biodegradable composition, wherein the disposable product is packing material or a consumer product.

In certain embodiments, the biodegradable compositions of the invention can be used in various embodiments from single-use products to durable products and in a wide range of applications, from packaging to medical, consumer products and many more.

In various embodiments, the invention encompasses a biodegradable resin composition comprising:
a. about 10 to about 99.99% (w/w) of one or more biodegradable thermoplastic polymers;
b. about 0.01 to about 40% (w/w) of one or more plasticizers;
c. about 0 to about 20% (w/w) of one or more of inorganic fillers;
d. about 0 to about 20% (w/w) of one or more of biomass fillers;
e. about 0 to about 10% (w/w) of one or more of additives such as coupling agents, processing aids, compatibilizing agents, chain extenders, initiators, peroxides, impact modifiers and pigments,
f. wherein, the composition exhibits a force recovery property shortly after being stretched to a certain strain and then returned to a lower strain and held for a period of time.

In certain embodiments, the composition exhibits a minimum of about 5% force recovery within about 60 seconds, while being held at a holding strain of at least 5% after returning from an initial strain of at least about 10% that falls beyond the elastic region on the tensile stress-strain curve of the resin composition.

In certain embodiments, the biodegradable thermoplastic polymer comprises one or more biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates, and a combinations thereof.

In certain embodiments, the plasticizers comprise one or more plant-based oils obtained from vegetables, nuts, grains, seeds.

In certain embodiments, the oils comprise corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

In certain embodiments, the inorganic fillers comprise wollastonite, mica, clay, calcium carbonate, glass fiber, talc, aluminum silicate, zirconium oxide, sepiolite, gypsum, and combinations thereof.

In certain embodiments, the biomass comprises distillers' grains, vinasse, vinegar residues, wood fiber, starch, modified starch, thermoplastic starch, agricultural cellulosic matter, straw, stalk, shive, hurd, bast, leaf, seed, fruit, and perennial grass, which may consist of chopped pieces, particulates, dust, or flour or combinations thereof.

In certain embodiments, the composition exhibits a 90% disintegration completion within about 180 to about 365 days at ambient temperature.

In certain embodiments, the composition exhibits a 90% disintegration completion within about 180 to about 365 days in soil at ambient temperature.

In certain embodiments, the composition exhibits more than 90% disintegration in less than 84 days under thermophilic temperature conditions, and wherein the composition exhibits more than 90% biodegradation in less than 180 days under thermophilic temperature conditions.

In certain embodiments, the components are mixed and melt-compounded together in a polymer processing equipment or apparatus comprising a batch mixer, a twin screw extruder or a single screw extruder at elevated temperatures for a time period of several seconds to several minutes.

In certain embodiments, the bio-based carbon content of the composition is up to 100%.

In certain embodiments, the biodegradable resin composition can be used for the preparation of articles of any thickness and rigidity made using conventional polymer processing techniques comprising blown and cast film extrusion, compression molding and injection molding techniques.

### DETAILED DESCRIPTION OF THE INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments and are not intended to limit the present invention.

### Definitions

The term “biobased” or “bio-based” refers to compositions that are derived from plant matter instead of being made from petroleum or natural gas. Because these are plant-based, there is a tendency to assume that the type of plastic must be biodegradable. However, this is not the case for all plant-based compositions. The bio-based compositions of the invention can be designed to biodegrade in less than 6 months.

The term “thermoplastic”, as used herein, refers to a polymer, which softens when heated, becomes moldable and pliable, and then solidifies when cooled.

The prefix “bio” as used herein refers to a material that has been derived from a renewable biological resource.

The terms “blend” and “resin” as used herein interchangeably, refer to a homogeneous mixture of two or more polymers and plasticizers along with other ingredients.

The term “machine direction” or “MD” refers to the direction parallel to the pull of an extruded polymer film from the die during a cast extrusion process.

The term “transverse direction” or “TD” refers to the direction perpendicular to the pull of an extruded polymer film from the die during a cast extrusion process.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The compositions of the invention biodegrade within 12 months. Compostable plastic is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstock for plastic production include, but are not limited to, corn starch, corn stalks, sugarcane stems, cellulose, and various oils and fats from renewable sources.

The term “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10% of its original dry weight after twelve weeks (84 days) in a controlled thermophilic composting test and sieved through a 2.0-mm mesh.

The term “polyesters” refers to polymers of the invention that are obtained, for example, by aliphatic diols, aliphatic dicarboxylic acids, and aromatic dicarboxylic acids/esters. The term polyesters also includes aliphatic-aromatic polyesters. The biodegradable thermoplastic polyesters of the current invention include but are not limited to, polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

As used herein, “recovery” or “force recovery” refers to the ability of the material (resin composition developed herein) to recover a percentage of its strength within its plastic region, within a specified time frame. The force recovery can be measured using testing equipment such as a universal testing machine (UTM) via the following procedure: The material is first stretched to an “initial strain” beyond the elastic region on its tensile stress-strain curve, at a specific strain rate. At this strain, the “maximum force” is recorded. Following this, the sample is returned from its initial strain to a “holding strain”, at a specific strain rate, and held at this holding strain for a specific period of time referred to as the “holding time”. The final step involves measuring the percentage of the force recovered relative to the maximum force recorded, which is then reported as the force recovery of the composition.

As used herein, “additive” could refer to material used to enhance a targeted property or function of material and/or composition, which could be in any form such as solid, liquid, powder, fiber, or crystal.

The term polyhydroxyalkanoates (PHAs) refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

As used herein, “wt. %”, “parts by mass (w/w)” or “parts by mass % (w/w)” refer to the percentage weight of an ingredient with respect to the total weight of a composition.

### Compositions of the Invention

The present invention is concerned with the development of biodegradable thermoplastic resin compositions that exhibit force recovery properties. In general, the biodegradable compositions of the invention can be considered valid alternative materials to those produced from petroleum resources.

In certain embodiments, the compositions include one or more polymers. In these embodiments, one or more of these polymers are biodegradable thermoplastic polyesters including, but not limited to, polylactic acid, polycaprolactone, polybutylene succinate, polybutylene succinate adipate, polybutylene succinate terephthalate, polybutylene adipate terephthalate, or polyhydroxyalkanoates.

The embodiment compositions may include, but are not limited to, any of the following polymer combinations.

In certain embodiments, the biodegradable thermoplastic polyesters include polylactic acid and polycaprolactone.

In certain embodiments, the biodegradable thermoplastic polyesters include polylactic acid and polybutylene succinate.

In certain embodiments, the biodegradable thermoplastic polyesters include polylactic acid and polybutylene succinate adipate.

In certain embodiments, the biodegradable thermoplastic polyesters include polylactic acid and polybutylene succinate terephthalate.

In certain embodiments, the biodegradable thermoplastic polyesters include polylactic acid and polybutylene adipate terephthalate.

In certain embodiments, the biodegradable thermoplastic polyesters include polylactic acid and polyhydroxyalkanoates.

In certain embodiments, the biodegradable thermoplastic polyesters include polycaprolactone and polybutylene succinate.

In certain embodiments, the biodegradable thermoplastic polyesters include polycaprolactone and polybutylene succinate adipate.

In certain embodiments, the biodegradable thermoplastic polyesters include polycaprolactone and polybutylene succinate terephthalate.

In certain embodiments, the biodegradable thermoplastic polyesters include polycaprolactone and polybutylene adipate terephthalate.

In certain embodiments, the biodegradable thermoplastic polyesters include polycaprolactone and polyhydroxyalkanoates.

In certain embodiments, the biodegradable thermoplastic polyesters include polybutylene succinate and polybutylene succinate adipate.

In certain embodiments, the biodegradable thermoplastic polyesters include polybutylene succinate and polybutylene succinate terephthalate.

In certain embodiments, the biodegradable thermoplastic polyesters include polybutylene succinate and polybutylene adipate terephthalate.

In certain embodiments, the biodegradable thermoplastic polyesters include polybutylene succinate and polyhydroxyalkanoates.

In certain embodiments, the biodegradable thermoplastic polyesters include polybutylene succinate adipate and polybutylene succinate terephthalate.

In certain embodiments, the biodegradable thermoplastic polyesters include polybutylene succinate adipate and polybutylene adipate terephthalate.

In certain embodiments, the biodegradable thermoplastic polyesters include polybutylene succinate adipate and polyhydroxyalkanoates.

In certain embodiments, the biodegradable thermoplastic polyesters include polybutylene succinate terephthalate and polybutylene adipate terephthalate.

In certain embodiments, the biodegradable thermoplastic polyesters include polybutylene succinate terephthalate and polyhydroxyalkanoates.

The abovementioned embodiments are not limited to binary combinations of biodegradable polyesters, but could encompass combinations of three or more biodegradable thermoplastic polyesters.

In certain embodiments, the biomass includes, but is not limited to, distillers' grains, vinasse, vinegar residues, wood fiber, starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the inorganic filler includes, but is not limited to, wollastonite, mica, clay, calcium carbonate, glass fiber, talc, aluminum silicate, zirconium oxide, gypsum, and other minerals and a combination thereof.

In certain embodiments, the plasticizers encompass, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the coupling agent or compatibilizer includes, but is not limited to, titanate, aluminate, γ-aminopropyltriethoxysilane, γ-(2,3) epoxy (propoxy) propyltrimethoxysilane, γ-methacryloxypropyltrimethoxysilane, lactic acid, formic acid, stearic acid, tannic acid, malic acid, citric acid, aspartic acid, ascorbic acid, acetic acid, tartaric acid.

In certain embodiments, the compositions further include modified starch which is a product of at least one starch or its derivatives, including any known starch material. Preferred starches can include any starch or modified starch that is initially in a native state as a granular solid, and obtained from sources such as, but not limited to cereal grains (e.g, corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and additives such as but not limited to water, crosslinkers, initiators, alkalizers, acidifiers, peroxides, coupling agents, fillers, compatibilizing agents, pigments and combinations thereof.

In certain embodiments, the compositions further include additives such as coupling agents, compatibilizing agents, processing aids, chain extenders, initiators, peroxides, impact modifiers and pigments.

The biodegradable resin composition comprises about 10 to about 99.99% (w/w) of one or more biodegradable thermoplastic polymers; about 0.01 to about 40% (w/w) of one or more plasticizers; about 0 to about 20% (w/w) of one or more of inorganic fillers; about 0 to about 20% (w/w) of one or more of organic fillers; about 0 to about 10% (w/w) of one or more of additives such as coupling agents, compatibilizing agents, processing aids, chain extenders, initiators, peroxides, impact modifiers and pigments.

### Biodegradable Resin Composition Production

The aforementioned ingredients may be processed together in various embodiments. In one embodiment, all ingredients are premixed and melt-processed together. In another embodiment, the biodegradable thermoplastic polymer(s) will be plasticized, i.e. melt-processed with at least one plasticizer, and then optionally melt-processed with filler and/or other additives. In yet another embodiment, all or one of the biodegradable thermoplastic polymer(s) will be melt-processed, followed by the addition of other biopolymer(s), the plasticizer(s), and optionally filler and/or additives. Furthermore, the optional additives may be added to the biodegradable thermoplastic polymer(s) before the addition of the plasticizer(s). The blending or processing of the ingredients is not limited to the aforementioned embodiments but may include all possible ingredient combination embodiments.

In various embodiments, the blending of the aforementioned ingredients may be achieved using mixing and melt-compounding equipment with adjustable and controllable temperatures and mixing speeds, such as a single or twin screw extruder or a batch kneader. In a batch kneader, the processing temperature profile may range from 50 to 250° C., and the processing time may be between about 1 to about 60 minutes. Alternatively, in embodiments where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be formed into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion, injection or compression temperature is typically within the range used in the melt-processing and compounding of the resins and ingredients.

In other embodiments, the invention includes methods for preparing the biodegradable composition comprising the following steps; mixing uniformly and thoroughly all raw materials of the biodegradable composition at higher than ambient temperatures to prepare the biodegradable composition.

In other embodiments, the invention includes methods for preparing the biodegradable composition comprising the following steps; mixing uniformly and thoroughly, polymers at higher than ambient temperatures and then mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly, specific groups or singular raw materials in certain order at higher than ambient temperatures to prepare the biodegradable composition.

In certain embodiments, the method further comprises forming any articles in any shape and rigidity using conventional polymer processing techniques such as thermoforming, hot press, vacuum forming, cast extrusion, film blowing, injection molding or compression molding.

In certain embodiments, the invention encompasses compositions and methods of making a disposable product, comprising the biodegradable composition of the invention, wherein the disposable products are packaging materials or consumer products.

### Force Recovery Measurement Test Method

The force recovery can be measured using a universal testing machine (UTM) via different methods including but not limited to the following:

Testing can be conducted using a sample size specified by ASTM D882, measuring 2 cm in width and 15 cm in length. This includes a 10 cm testing area and 2.5 cm on each side reserved for gripping.
(i) The sample is stretched to an “initial strain” of at least 10% that falls beyond the elastic region on the tensile stress-strain curve, with a strain rate between 0.1 to 1500 mm/min.
(ii) The “maximum force” that causes this strain is recorded.
(iii) The sample is returned from the initial strain to a minimum strain of 5% with a strain rate of 0.1 to 1500 mm/min and is held under this “holding strain” for a certain amount of time, typically from about a few seconds to about 60 seconds, during which the force being recovered is measured.
(iv) The percentage of the force recovered at any given time under the holding strain is then calculated with respect to the recorded maximum force from step (ii) and is reported as the force recovery of the composition at that time under the holding strain.

In one embodiment, the force recovery is evaluated by stretching the sample at a strain rate of 50 mm/min until it reaches a strain of 20%. Once this strain is achieved, the grips retract at a rate of 500 mm/min until a strain of 6% is attained. The sample's force recovery is then monitored for 12 seconds. The maximum percentage of force recovery reached within 12 seconds with respect to the maximum force reached during the initial stretch, is then calculated.

In one embodiment, the force recovery is evaluated by stretching the sample at a strain rate of 50 mm/min until it reaches a strain of 30%. Once this strain is achieved, the grips retract at a rate of 500 mm/min until a strain of 9% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 40%. Once this strain is achieved, the grips retract at a rate of 500 mm/min until a strain of 12% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 50%. Once this strain is achieved, the grips retract at a rate of 500 mm/min until a strain of 15% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 50 mm/min until it reaches a strain of 20%. Once this strain is achieved, the grips retract at a rate of 50 mm/min until a strain of 10% is attained. The sample's force recovery is then monitored for 60 seconds. The maximum percentage of force recovery reached within 60 seconds, with respect to the maximum force reached during the initial stretch, is then calculated.

In one embodiment, the force recovery is evaluated by stretching the sample at a strain rate of 10 mm/min until it reaches a strain of 50%. Once this strain is achieved, the grips retract at a rate of 200 mm/min until a strain of 15% is attained. The sample's force recovery is then monitored for 60 seconds. The maximum percentage of force recovery reached within 60 seconds, with respect to the maximum force reached during the initial stretch, is then calculated.

The force recovery test is not limited to the aforementioned procedures and could include any other initial strains, holding times, holding strains, strain rates and sample size.

### General Embodiments of the Invention

The invention generally encompasses compositions and methods of manufacturing a biodegradable composition including, but not limited to, about 10 to about 99.99% (w/w) of one or more biodegradable thermoplastic polymers; about 0.01 to about 40% (w/w) of one or more plasticizers; about 0 to about 20% (w/w) of one or more of inorganic fillers; about 0 to about 20% (w/w) of one or more of organic fillers; about 0 to about 10% (w/w) of one or more of additives such as coupling agents, processing aids, compatibilizing agents, chain extenders, initiators, peroxides, impact modifiers and pigments.

The methods of manufacturing of the aforementioned composition combinations may be achieved using mixing and melt-compounding equipment with adjustable and controllable temperatures and mixing speeds, such as a single or twin screw extruder or a batch kneader. In a batch kneader, the processing temperature profile may range from about 50 to about 250° C., and the processing time may be between about 1 to 60 minutes. Alternatively, in scenarios where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be extruded into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion, injection or compression temperature is typically within the range used in the melt-processing and compounding of the resins and ingredients.

In certain embodiments, the compositions exhibit a bio-based carbon content of up to 100%. In certain embodiment, the composition exhibits a bio-based carbon content of about 10%, 20%, 30%, 40%, 50%, 60%, 70%, 80%, 90%, 95%, or about 100%.

In certain embodiments, the composition exhibits 10%, 20%, 30%, 40%. 50%. 60%, 70%. 80%, or 90% disintegration completion within about 180 to about 365 days at ambient temperature.

In certain embodiments, the composition exhibits 10%, 20%, 30%, 40%. 50%. 60%, 70%. 80%, or 90% disintegration completion within about 180 to about 365 days in soil.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits 10%, 20%, 30%, 40%. 50%. 60%, 70%. 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days under thermophilic temperature conditions.

In certain embodiments, the composition exhibits more than 90% biodegradation in less than 90, 100, 110, 120, 130, 140, 150, 160, 170, 175, or 180 days under thermophilic temperature conditions.

In certain embodiments, the composition exhibits a force recovery of more than 10%, in machine direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 8% in transverse direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 6%, in machine direction, after an initial strain of 20% was applied at a rate of 500 mm/min and then reduced to a holding strain of 6% at a rate of 500 mm/min and held constant for 12 seconds.

In certain embodiments, the composition exhibits a force recovery of more than 7% in transverse direction, after an initial strain of 20% was applied at a rate of 500 mm/min and then reduced to a holding strain of 6% at a rate of 500 mm/min and held constant for 12 seconds.

### EXAMPLES

Example 1: A kneader was pre-heated to 230° C. before the addition of 60.9 and 26.1 wt. % of PBAT and PLA, respectively. The temperature of the kneader was reduced to 190° C. and the polymers were allowed to mix for 5 minutes under a mixing speed of 35 rpm until a uniform melt was formed. Then 13 wt. % ATBC as plasticizer, was charged into the kneader and mixing continued for another 10 minutes under the presence of shear and heat. The resulting material was extracted from the kneader, cooled to room temperature and crushed using a mechanical crusher.

The crushed material was extruded into film with an average thickness of 0.28 mm and a width of 10-12 inches, using a cast film extruder with a temperature profile of 140 to 165° C. and a screw speed of 50 rpm. The film was chilled and pulled via a set of chiller, guiding and winding rollers to be collected with a spool. The MFI and mechanical properties of the produced resin and the extruded film were then evaluated using a melt flow indexer and a UTM according to ASTM methods, as well as the force recovery test method defined previously. The results are shown in Table 1.

Example 2: A kneader was pre-heated to 230° C. before the addition of 58.3 wt. % PBSA and 25 wt. % PLA. The temperature of the kneader was reduced to 190° C. and the polymers were allowed to mix for 5 minutes under a mixing speed of 35 rpm until a uniform melt was formed. Then 16.7 wt. % ATBC as plasticizer, was charged into the kneader and mixing continued for another 10 minutes under the presence of shear and heat. The resulting material was extracted from the kneader, cooled to room temperature and crushed using a mechanical crusher.

The crushed material was extruded into film with an average thickness of 0.27 mm and a width of 10-12 inches, using a cast film extruder with a temperature profile of 160 to 190° C. and a screw speed of 50 rpm. The film was chilled and pulled via a set of chiller, guiding and winding rollers to be collected with a spool. The MFI and mechanical properties of the produced resin and the extruded film were then evaluated using a melt flow indexer and a UTM according to ASTM methods, as well as the force recovery test method defined previously. The results are shown in Table 1.

Example 3: A premix of 59.5 wt. % PBSA, 12.8 wt. % PHBV, 12.8 wt. % PLA and 14.9 wt. % ATBC was fed into a twin screw extruder with a screw speed of 100 rpm and a temperature profile between 140 to 175° C. to make pellets of this composition.

The pellets were extruded into film with an average thickness of 0.28 mm and a width of 10-12 inches, using a cast film extruder with a temperature profile of 160 to 170° C. and a screw speed of 50 rpm. The film was chilled and pulled via a set of chiller, guiding and winding rollers to be collected with a spool. The MFI and mechanical properties of the produced resin and the extruded film were then evaluated using a melt flow indexer and a UTM according to ASTM methods, as well as the force recovery test method defined previously. The results are shown in Table 1.

Example 4: A kneader was pre-heated to 200° C. before the addition of 60.8 wt. % PBAT and 26.1 wt. % PLA. The temperature of the kneader was reduced to 185° C. and the polymers were allowed to mix for 3 minutes under a mixing speed of 35 rpm until a uniform melt was formed. At this point, 0.1 wt. % of a processing aid was added. After 2 minutes of further mixing, 13 wt. % of isosorbide diester as plasticizer, was added and mixing continued for another 10 minutes under the presence of shear and heat. The resulting material was extracted, cooled to room temperature crushed using a mechanical crusher.

The crushed material was extruded into film with an average thickness of 0.23 mm and a width of 10-12 inches, using a cast film extruder with a temperature profile of 160 to 190° C. and a screw speed of 50 rpm. The film was chilled and pulled via a set of chiller, guiding and winding rollers to be collected with a spool. The MFI and mechanical properties of the produced resin and the extruded film were then evaluated using a melt flow indexer and a UTM according to ASTM methods, as well as the force recovery test method defined previously. The results are shown in Table 1.

Example 5: A kneader was pre-heated to 210° C. before the addition of 69.6 wt. % PBAT and 17.4 wt. % PLA. The temperature of the kneader was reduced to 190° C. and the polymers were allowed to mix for 3 minutes under a mixing speed of 35 rpm until a uniform melt was formed. At this point, 13 wt. % of isosorbide diester as plasticizer, was added and mixing continued for another 12 minutes under the presence of shear and heat. The resulting material was extracted, cooled to room temperature crushed using a mechanical crusher.

The crushed material was extruded into film with an average thickness of 0.32 mm and a width of 10-12 inches, using a cast film extruder with a temperature profile of 160 to 190° C. and a screw speed of 70 rpm. The film was chilled and pulled via a set of chiller, guiding and winding rollers to be collected with a spool. The MFI and mechanical properties of the produced resin and the extruded film were evaluated using a melt flow indexer and a UTM according to ASTM methods, as well as the force recovery test method defined previously. However, the composition showed no force recovery.

TABLE 1
Mechanical properties of polymer blends with plasticizers

| Properties | Example 1 | Example 2 | Example 3 | Example 4 | Example 5 |
|---|---|---|---|---|---|
| Thickness- | 0.28 | 0.27 | 0.28 | 0.23 | 0.32 |
| mm | | | | | |
| Stress at | 5.3 | 8.2 | 11.1 | 9.4 | 7.5 |
| Yield | | | | | |
| (MD)-MPa | | | | | |
| Stress at | 4.8 | 6.8 | 9.9 | 7 | 6.9 |
| Yield | | | | | |
| (TD)-MPa | | | | | |
| Stress at | 21.5 | 18.2 | 21.5 | 25.2 | 20.2 |
| Break (MD)- | | | | | |
| MPa | | | | | |
| Stress at | 10.7 | 11.6 | 13.2 | 6.4 | 12.4 |
| Break (TD)- | | | | | |
| MPa | | | | | |
| Young's | 44.6 | 122.2 | 285.5 | 592.2 | 268.6 |
| Modulus | | | | | |
| (MD)-MPa | | | | | |
| Young's | 40.5 | 105.8 | 233.4 | 126.5 | 98 |
| Modulus | | | | | |
| (TD)-MPa | | | | | |
| Strain at | 35.9 | 16.8 | 19.9 | 2.2 | 13.7 |
| Yield (MD)- | | | | | |
| % | | | | | |
| Strain at | 29.9 | 16.6 | 19.8 | 10.3 | 12.9 |
| Yield (TD)- | | | | | |
| % | | | | | |
| Strain at | 508 | 365 | 432.5 | 648.7 | 617.8 |
| Break (MD)- | | | | | |
| % | | | | | |
| Strain at | 330 | 211 | 281.5 | 147.4 | 421 |
| Break (TD)- | | | | | |
| % | | | | | |
| Force | 10.4** | 1.1** | 6.7* | 5.7* | 0*** |
| recovery | | | | | |
| (MD)-% | | | | | |
| Force | 8.6** | 8.7** | 3.6* | 7.9* | 0*** |
| recovery | | | | | |
| (TD)-% | | | | | |
| MFI @ 190° | 26.3 | 22.2 | 43.7 | 27.3 | 19.2 |
| C., 2.16 kg- | | | | | |
| gr/10 min | | | | | |

*Force recovery after 20% initial strain and at 6% holding strain,
**Force recovery after 30% initial strain and at 9% holding strain, and
***Force recovery after 40% initial strain and at 12% holding strain, (The strain rate for the force recovery test was 500 mm/min and the holding time was 12 seconds for all the examples.)

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A biodegradable resin composition comprising:
i. about 10 to about 99.99% (w/w) of one or more biodegradable thermoplastic polymers;
ii. about 0.01 to about 40% (w/w) of one or more plasticizers;
iii. about 0 to about 20% (w/w) of one or more of inorganic fillers;
iv. about 0 to about 20% (w/w) of one or more of biomass fillers;
v. about 0 to about 10% (w/w) of one or more of additives such as coupling agents, processing aids, compatibilizing agents, chain extenders, initiators, peroxides, impact modifiers and pigments,
wherein, the composition exhibits a force recovery property shortly after being stretched to a certain strain and then returned to a lower strain and held for a period of time.

2. The biodegradable resin composition of claim 1, wherein the composition exhibits a minimum of about 5% force recovery within about 60 seconds, while being held at a holding strain of at least 5% after returning from an initial strain of at least about 10% that falls beyond the elastic region on the tensile stress-strain curve of the resin composition.

3. The biodegradable resin composition of claim 1, where the biodegradable thermoplastic polymer comprises one or more biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates, and a combinations thereof.

4. The biodegradable resin composition of claim 1, wherein the plasticizers comprise one or more plant-based oils obtained from vegetables, nuts, grains, seeds, or combinations thereof, wherein the oils is selected from the group consisting of corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

5. The biodegradable resin composition of claim 1, where the inorganic fillers comprise wollastonite, mica, clay, calcium carbonate, glass fiber, talc, aluminum silicate, zirconium oxide, sepiolite, gypsum, and combinations thereof.

6. The biodegradable resin composition of claim 1, where the biomass comprises distillers' grains, vinasse, vinegar residues, wood fiber, starch, modified starch, thermoplastic starch, agricultural cellulosic matter, straw, stalk, shive, hurd, bast, leaf, seed, fruit, and perennial grass, which may consist of chopped pieces, particulates, dust, or flour or combinations thereof.

7. The biodegradable resin composition of claim 1, wherein the composition exhibits a 90% disintegration completion within about 180 to about 365 days at ambient temperature.

8. The biodegradable resin composition of claim 1, wherein the composition exhibits a 90% disintegration completion within about 180 to about 365 days in soil at ambient temperature.

9. The biodegradable resin composition of claim 1, wherein the composition exhibits more than 90% disintegration in less than about 12 weeks, and wherein the composition exhibits more than 90% biodegradation in less than 180 days under thermophilic temperature conditions.

10. A method of producing the biodegradable resin composition of claim 1, in which components are mixed and melt-compounded together in a polymer processing equipment or apparatus comprising a batch mixer, a twin screw extruder or single screw extruder at elevated temperatures for a time period of several seconds to several minutes.

11. The biodegradable resin composition of claim 1, where the bio-based carbon content of the composition is up to 100%.

12. The biodegradable resin composition of claim 1, for use in articles of any thickness and rigidity using conventional polymer processing techniques comprising blown and cast film extrusion, compression molding and injection molding techniques.
